(19) United States
(12) Patent Application Publication
(10) Pub. No.: US 2012/0006104 A1
(43) Pub. Date: Jan. 12, 2012

(54) High Temperature Chromatography Apparatus and Method Thereof

(75) Inventors: Dong Hyun Cho, Gyunggi-do (KR); Hee Jin Lee, Gyunggi-do (KR); Sung Chan Park, Gyunggi-do (KR); Suk Jin Ham, Seoul (KR)

(73) Assignee: SAMSUNG ELECTRO-MECHANICS CO., LTD., Gyunggi-do (KR)

(21) Appl. No.: 12/891,954

(22) Filed: Sep. 28, 2010

(30) Foreign Application Priority Data
Jul. 8, 2010 (KR) 1020100066010

(51) Int. Cl. G01N 30/16; G01N 21/33; G01N 1/10

(52) U.S. Cl. 73/61.55; 356/51; 73/863.11

(57) ABSTRACT

Disclosed herein are a high temperature chromatography apparatus and a method thereof. The high temperature chromatography apparatus includes: an eluent pump; a sample dissolving unit that uniformly dissolves an insoluble sample; an injecting unit that mixes and injects the sample and the eluent; a column unit that separates materials; a detector that detects materials; a temperature measuring unit that measures the temperature of the sample dissolving unit, the injecting unit, and the column unit; a heating device that increases or decreases the temperature of the sample dissolving unit, the injecting unit, and the column unit; a temperature controller that maintains the measured temperature and the setting temperature to be the same as each other; and a controller.

### CROSS REFERENCE TO RELATED APPLICATION

This application claims the benefit of Korean Patent Application No. 10-2010-0066010, filed on Jul. 8, 2010, entitled “High Temperature Chromatography Apparatus and Method Thereof”, which is hereby incorporated by reference in its entirety into this application.

### 1. TECHNICAL FIELD

The present invention relates to a high temperature chromatography apparatus and a method thereof

### 2. DESCRIPTION OF THE RELATED ART

Chromatography is a method of separating samples using different moving speeds according to characteristics of the samples when a mixing solution, in which samples are mixed flows with a stationary phase together with a mobile phase, and a representative material separating technology that is applied to various fields including chemistry, biotechnology, medicine, or the like.

Generally, as high performance liquid chromatography for separating/analyzing synthetic polymer, there are gel permeation chromatography (GPC), solvent gradient interaction chromatography (SGIC), temperature gradient interaction chromatography (TGIC) apparatuses, and so on. These methods use a liquid solvent that can uniformly melt the synthetic polymer with a mobile phase, wherein the liquid solvent is generally referred to as an eluent.

Since the above-mentioned HPLC apparatus controls temperature using a water circulator, it can control temperatures between 0 to 100° C. and separate materials by using a normal temperature-HLPC apparatus because most thermoplastic synthetic polymer samples are dissolved with organic solvents such as THFs, chloroforms, acetonitriles, alcohols, or the like, which are dissolved at approximately normal temperatures.

In addition, the HLPC apparatus can quickly heat a column to a temperature of 5 to 100° C./min by using a Peltier apparatus instead of a water circulator.

However, since most of the apparatuses according to the prior art are used within normal temperatures to 100° C. as described above, it cannot be used to separate polymer materials (insoluble polymer) that cannot be dissolved within this temperature range.

That is, most of hydrocarbon-based (PE, PE. etc.), conductive polymer, and LCP polymer samples, all of which are generally insoluble synthetic polymer, are not dissolved at normal temperatures and a solvent that can dissolve these polymers are extremely limited. Therefore, these polymers are dissolved in only trichlorobenzen (TCB), NMP, etc., which are specific solvents. Consequently, it is difficult to separate these insoluble synthetic polymer materials using the apparatuses according to the prior art.

### SUMMARY OF THE INVENTION

The present invention has been made in an effort to provide a high temperature chromatography apparatus whose injecting unit, column unit, and detector are configured to be operated at high temperature to perform a process from preparation/injection of insoluble polymer samples to separation, detection, and collection without precipitating a polymer or coagulation of a mobile phase, and a method thereof.

A high temperature chromatography apparatus according to a preferred embodiment includes: an eluent pump that supplies eluent used as a mobile phase stored in an eluent reservoir; a sample dissolving unit that stores an insoluble polymer sample and uniformly dissolves the stored insoluble polymer sample at high temperature; an injecting unit that mixes and injects the polymer sample dissolved in the sample dissolving unit and the eluent supplied from the eluent pump; a column unit that separates materials from a mixing solution of the sample injected from the injecting unit and the eluent; a detector that detects desired materials from the materials separated and supplied from the column unit; a temperature measuring unit that measures the temperature of the sample dissolving unit, the injecting unit, and the column unit; a heating device that increases or decreases the temperature of the sample dissolving unit, the injecting unit, and the column unit; a temperature controller that controls the heating device by comparing the temperature measured in the temperature measuring unit with a setting temperature to maintain the measured temperature and the setting temperature to be the same as each other; and a controller that controls the sample dissolving unit, the eluent pump, the injecting unit, the detector, the temperature measuring unit, and the temperature controller.

The high temperature chromatography apparatus further includes a splitter that is connected to a discharging pipe of the detector and processes and splits materials detected and discharged in the detector.

The eluent stored in the eluent reservoir is at least one of halogenated hydrocarbon[trichlorobenzene (TCB)], DMF, DMSO, m-Cresol, Pyridine, Tetrachloroethane, THF, NMP, Formic Acid, Sulfuric Acid, Phenyl-based organic solvent, and a combination thereof.

The insoluble polymer sample dissolved in the sample dissolving unit is at least one of a hydrocarbon-based sample (single polymer PE, PP, etc., and all the copolymers including PE and PP), a conductive polymer sample, and an LCP polymer sample.

The column unit is one of a reversed phase chromatography column, a normal phase chromatography column, a size-exclusion chromatography column, an ion exchange chromatography column, and a combination of at least one thereof.

The detector is one of an evaporation light scattering (ELSD) detector, an UV-Vis detector, and a refractive index detector.

The temperature measuring unit includes a plurality of temperature sensors to separately measure temperature for each of the sample dissolving unit, injecting unit, column unit, and detector.

The heating device includes a plurality of heaters to separately increase or decrease the temperature of each of the sample dissolving unit, the injecting unit, the column unit, and the detector.

The sample dissolving unit includes: a sample reservoir that stores an insoluble polymer sample; an ultrasonic oscillator that applies an ultrasonic wave to the insoluble polymer sample at a high temperature state and uniformly dissolves the insoluble polymer sample; and a fluid dissolving pump that moves the sample and the solvent to dissolve the insoluble polymer sample at a high temperature state,

The injecting unit includes: a sample pump that receives the samples uniformly dissolved in the sample dissolving unit at a high temperature state and supplies the samples the sample by the pumping operation; and an injection value that includes an eluent injecting port, a sample injecting port, and a sample drawing port and mixes the eluent delivered through the eluent injecting port through the eluent pump with a sample delivered through the sample injecting port from the sample pump and injects the mixture to the column unit through the sample drawing port.

The detector includes: a light source that uniformly generates and emits light having a predetermined wavelength; a sample cell that passes through the sample input from the column unit and is positioned on an optical path of light emitted from the light source to partially absorb light input from the light source; a reference cell that contacts the sample cell, passes through the eluent as the reference material, and is positioned on the optical path of light emitted from the light source to partially absorb light; a mirror that reflects light input through the sample cell to pass through the reference cell; a heat exchanger that allows a passage to transmit materials input and output to and from the sample cell and a passage to transmit the eluent input and output to and from the reference cell to be adjacent to each other to make the temperature of the internal material of the sample cell and the reference cell to be the same as each other during the temperature gradient experiment; a light receiving device that measures the change in optical path due to the difference between refractive indexes of internal cell materials by passing light emitted from the light source through the sample cell and the reference cell; and an optical fiber assembly used to separate the light source and the light receiving device in a high temperature region.

A high temperature chromatography method according to a preferred embodiment includes: (A) measuring temperature of a sample dissolving unit, an injecting unit, a column unit, and a detector by a temperature measuring unit and allowing the temperature controller to compare the measured temperature with the setting temperature to control the temperature of the sample dissolving unit, the injecting unit, the column unit, and the detector to setting temperature; (B) uniformly dissolving an insoluble polymer sample by the sample dissolving unit; (C) mixing the dissolved insoluble polymer sample with an eluent and injecting it into the column unit by the injecting unit; (D) separating and discharging materials by the column unit and detecting sample materials by the detector; and (E) measuring the temperature of the sample dissolving unit, the injecting unit, the column unit, and the detector by the temperature measuring unit as steps (B) to (D) progress and allowing the temperature controller to compare the measured temperature with the setting temperature so that the temperature of the sample dissolving unit, the injecting unit, the column unit, and the detector is maintained at setting temperature.

The high temperature chromatography method further includes after step (D), (F) processing and splitting materials discharged by a splitter connected to the discharging pipe of the detector.

The eluent stored in the eluent reservoir is at least one of halogenated hydrocarbon[trichlorobenzene (TCB)], DMF, DMSO, m-Cresol, Pyridine, Tetrachloroethane, THF, NMP, Formic Acid, Sulfuric Acid, Phenyl-based organic solvent, and a combination thereof.

The insoluble polymer sample is at least one of a hydrocarbon-based (single polymer PE, PP, etc., and all the copolymers including PE and PP) sample, a conductive polymer sample, and an LCP polymer sample.

Step (A) includes: (A-1) measuring the temperature of the sample dissolving unit, the injecting unit, the column unit, and the detector by the temperature measuring unit; (A-2) allowing the temperature controller to compare the measured temperature measured with the setting temperature; and (A-3) when the temperature measured is different from the setting temperature, allowing the temperature controller to control the heating device to maintain the temperature of the sample dissolving unit, the injecting unit, the column unit, and the detector at the setting temperature.

Step (C) includes: (C-1) delivering the eluent in the eluent reservoir to the injecting unit by using the eluent pump; (C-2) delivering the polymer sample in the sample dissolving unit to the injecting unit in a state maintained at high temperature; and (C-3) mixing the eluent delivered from the eluent pump with the sample delivered from the sample dissolving unit and injecting it to the column unit.

Step (D) includes: (D-1) separating materials by the column unit and discharging the sample made of eluent and polymer; (D-2) allowing the reference cell included in the detector to store the discharged eluent as a reference material; (D-3) controlling the temperature of the discharged sample by using the heat exchanger so that the temperature of the discharged sample is equal to the temperature of the reference material in the reference cell and then, passing the sample through the sample cell configuring the detector; (D-4) generating and emitting light passing through the sample cell and the reference cell from the light source included in the detector; and (D-5) detecting desired materials by allowing the light receiving device included in the detector to measure light intensity input through the sample cell and the reference cell.

Step (E) includes: (E-1) measuring the temperature of the sample dissolving unit, the injecting unit, the column unit, and the detector by the temperature measuring unit while steps (B) to (D) are performed; (E-2) allowing the temperature controller to comapre the measured temperature with the setting temperature; (E-3) when the measured temperature is different from the setting temperature, allowing the temperature controller to control the heating device to control temperature of the sample dissolving unit, the injecting unit, the column unit, and the detector; and (E-4) determining whether the material separating process ends by the temperature controller and if not, repeating the steps (E-1) to (E-4).

### BRIEF DESCRIPTION OF THE DRAWINGS

FIG. 1 is a configuration diagram of a high temperature chromatography apparatus according to a first preferred embodiment of the present invention;

FIG. 2 is a detailed configuration diagram of a sample dissolving unit and an injecting unit of FIG. 1;

FIG. 3 is a configuration diagram of a detector of FIG. 1; and

FIG. 4 is a flow chart of a high temperature chromatography method according to the first preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

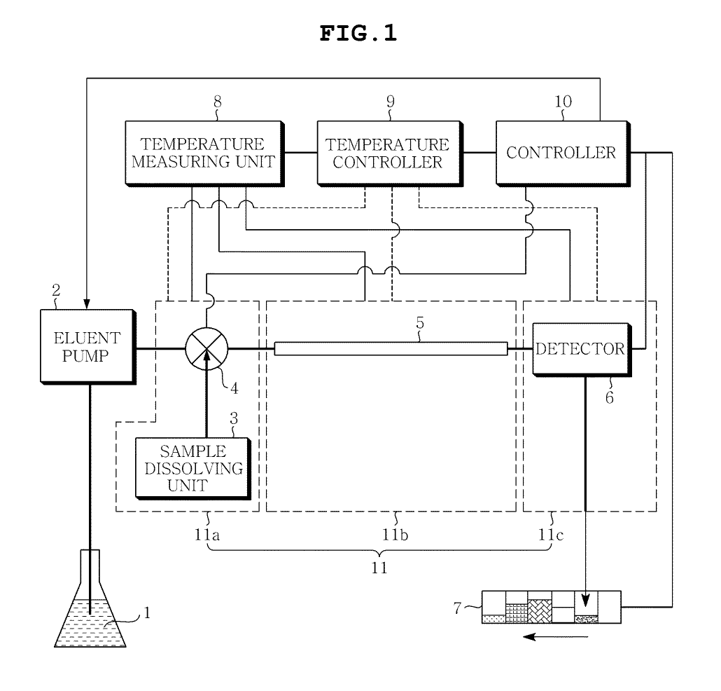

FIG. 1 is a configuration diagram of a high temperature chromatography apparatus according to a first preferred embodiment of the present invention.

Referring to FIG. 1, a high temperature chromatography apparatus according to a first preferred embodiment of the present invention is configured to include an eluent reservoir 1 that stores a solvent used as a mobile phase, an eluent pump 2 that supplies the eluent, a sample dissolving unit 3, an injecting unit 4 that injects a sample, a column unit 5 that separates materials, a detector 6, a splitter 7, a temperature measuring unit 8 that measures temperature of a moving path of the sample of the sample dissolving unit 3-the injecting unit 4-the column unit 5-the detector 6, a temperature controller 9 controlling a heating device 11 that maintains the temperature of the moving path of the sample of the dissolving unit 3-the injecting unit 4-the column unit 5-the detector 6 at high temperature, a controller 10 that controls the pump 2-the sample dissolving unit 3-the injecting unit 4-the detector 6-the splitter 7-the temperature measuring unit 8-the temperature controller 9, and a heating device 11.

The eluent stored in the eluent reservoir 1 may use, for example, at least one of halogenated hydrocarbon[trichlorobenzene (TCB)], DMF, DMSO, m-Cresol, Pyridine, Tetrachloroethane, THF, NMP, Formic Acid, Sulfuric Acid, Phenyl-based organic solvent, and a combination thereof, in order to dissolve insoluble polymer samples that are dissolved at a high temperature of 120° C. or more.

The eluent pump 2, which is a typical high-pressure pump, serves to pump the mobile phase into the fixed column unit 5.

Next, the injecting unit 4 is an apparatus for injecting the sample. As the injected sample, hydrocarbon-based (including a single polymer such as PE, PP, etc., and all the copolymers including PE, PP), conductive polymer, and LCP polymer samples may be used.

The column unit 5, which is an apparatus for separating the components of the sample, may use the column for typical liquid chromatography. In particular, in the preferred embodiment of the present invention, the column may be a column for polymer analysis. The column unit may use one of a reversed phase chromatography column, a normal phase chromatography column, a size-exclusion chromatography column, an ion exchange chromatography column, and a combination of at least one thereof.

The detector 6, which is an apparatus to detect the components of the sample by separating and eluting the components of the sample, may use a typical detector used in the liquid chromatography, for example, an evaporative light scattering detector (ELSD), a UV-Vis detector, an refractive index detector, etc.

The splitter 7 is connected to the discharging pipe of the detector 6 to automatically split the separated polymer sample over time.

Next, the temperature measuring unit 8 representatively measures temperature of each factor using only a temperature sensor for each moving path of the sample of sample dissolving unit 3-injecting unit 4-column unit 5-detector 6 or measures temperature for each position of each factor by a plurality of temperature sensors.

In this case, as the temperature sensor, various kinds such as a platinum resistance temperature sensor, a thermocouple, a pyrometer, an IC thermometer, etc., may be used without limitations.

The temperature controller 9 controls a heating device 11 to maintain the temperature of the moving path of the sample of sample dissolving unit 3-injecting unit 4-column unit 5-detector 6 according to the temperature measured in the temperature measuring unit 8 at high temperature.

The heating device 11 includes a plurality of heaters 11a, 11b, and 11c. In the first preferred embodiment of the present invention, as shown in FIG. 1, the heater is installed for each component, that is, each component of sample dissolving unit 3-injecting unit 4-column unit 5-detector 6 and is controlled. However, the temperature of all the components can be controlled to rise or fall similarly by using an oven as the heater.

Further, in the first preferred embodiment of the present invention, each of the heaters 11a, 11b, and 11c may be an oven that heats all the components or a heating element or a radiator that is disposed at a passage through which the sample passes and is disposed near a part that can be separated from the passage while being selectively wound, coated, contacted, and inserted into only the part, thereby making it possible to control temperature while preventing damage to a part vulnerable to high temperature.

In this case, as the heaters 11a to 11c, the heating element or the radiator is configured to be separated for each component and to control each component, thereby making it possible to increase precision in the temperature control.

Further, the heating device 11 may be configured to heat components configured of an electrical conductor by directly flowing current into the components, including the column.

Parts of each component heated by the heating device 11 are made of materials that can withstand high temperature, such as stainless, steel, glass, ceramic, heat-resistant resin, composite materials, and so on. In this case, the length, diameter, and thickness of the passage should be created according to the increase in pressure due to high temperature and the passage may use a pressure control valve.

Meanwhile, when the heating device 11 may be used, parts (optical system, detector, electrical and electronic parts) among components of the detector 6 used at high temperature that can distort the analysis signals or lead to noise are separated from heated portions or may be implemented to have an independent cooling device.

Next, the controller 10 controls the eluent pump 2 to supply the solvent in the eluent reservoir 1 to the column unit 5, controls the injecting unit 4 to supply the sample in the sample dissolving unit 3 to the column unit 5, controls the detector 6 to separate, elute, and detect the components of the sample, controls the splitter 7 to automatically split the separated polymer sample over time, controls the temperature measuring unit 8 to measure the temperature of the moving path of the sample of sample dissolving unit 3-injecting unit 4-column unit 5-detector 6, controls the temperature controller 9 to maintain the temperature of the moving path of the sample of sample dissolving unit 3-injecting unit 4-column unit 5-detector 6 at the setting temperature through the control of the heating device 11.

The operation of the high temperature chromatography apparatus configured as described above according to the present invention will now be described.

First, the sample dissolving unit 3 uniformly dissolves the insoluble polymer sample at high temperature (T>120° C.) to deliver the insoluble polymer sample up to the injecting unit 4 maintained at high temperature in a high temperature state. In order to uniformly dissolve the sample, stirring, flowing, ultrasonic wave, etc., may be applied.

Then, the injecting unit 4 mixes the dissolved and delivered polymer sample with the eluent supplied from the eluent pump 2 and injects it to the column unit 5. In this case, since the eluent is heated at high temperature before encountering with the sample, the precipitation and coagulation of the sample is prevented even after the sample is mixed with the eluent. The sample uniformly mixed with the eluent supplied from the eluent pump 2 is separated according its molecular weight and chemical structure without precipitating, coagulating, clogging while passing through the temperature controllable column unit 5 in the high temperature region (T>120° C.).

To this end, the column unit 5 may use one of a reversed phase chromatography column, a normal phase chromatography column, a size-exclusion chromatography column, an ion exchange chromatography column, and a combination of at least one thereof, as described above.

Meanwhile, the used polymer and the corresponding solvent (eluent), the temperature gradient range, the temperature gradient speed will be described in Table 1.

TABLE 1

| | | Temper- | Temper- |
|---|---|---|---|
| | | ature | ature |
| | | gradient | gradient |
| Polymer | Solvent (Eluent) | range | speed |
| PE(Polyethylene), | halogenated | 80°~200° | 1~10°/min |
| PP(Polypropylene) | hydrocarbons (TCB: | | |
| | Trichlorobenzene) | | |
| Main-Chain | DMF, DMSO, | 50°~200° | 1~10°/min |
| Heterocyclic | Tetrachloroethane, | | |
| Polymers: | M-cresol, Pyridine, THF, | | |
| LCP & high functional | formic acid | | |
| polymer | | | |
| Poly(benzoxazoles) | | | |
| Poly(oxadiazoles) | | | |
| Poly(oxadiazolidines) | | | |
| Conducting Polymers | biphenyl, dimethyl-p- | 60°~200° | 1~10°/min |
| Poly(thiophenylene) | terphenyl, | | |
| | dichlorobiphenyl, | | |
| | hexachlorobiphenyl | | |

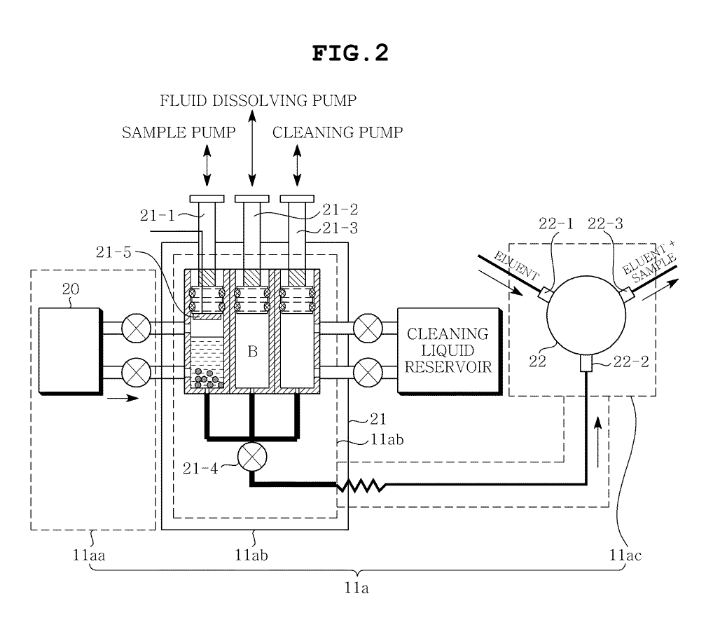

FIG. 2 is a detailed configuration diagram of the sample dissolving unit and the injecting unit of FIG. 1.

Referring to FIG. 2, the sample dissolving unit and the injecting unit of FIG. 1 are configured to include the sample reservoir 20, the pumping device 21, and the injection valve 22, wherein the sample reservoir 20, the pumping device 21, and the injection valve 22 are enclosed with the heating device 11a such that they may be maintained in the high temperature state.

Herein, the heating device 11a is separately implemented for each component (see reference numerals 11aa, 11ab, and 11ac). All the components may be implemented to be heated with one heating device or to be cooled.

Next, the pumping device 21 is configured to include a sample pump 21-1, a fluid dissolving pump 21-2, a cleaning pump 21-3, a valve 21-4, and a sample dissolving ultrasonic oscillator 21-5.

The sample pump 21-1 receives the sample dissolving solvent stored in the sample reservoir 20 in the high temperature state, melts the sample, and supplies the sample to the injection valve 22 by the pumping operation when the insoluble polymer sample in the solid state (powder, grain, tablet form) is loaded into the cylinder. In this case, in order to uniformly and efficiently dissolve the insoluble sample, ultrasonic wave is applied to the sample by the ultrasonic oscillator 21-5 mounted in the cylinder or the sample pump 21-1 and the fluid dissolving pump 21-2 are alternately operated in an opposite direction to each other, thereby making it possible to move the sample and the solvent between two pumps.

The cleaning pump 21-3 receives the cleaning liquid from the cleaning liquid reservoir and supplies the cleaning liquid to the injection valve 22 by the pumping operation.

The valve 21-4 included in the pumping device 21 provides the passage according to the control of the controller 10. The valve 21-4 supplies the dissolved sample supplied by the pumping operation of the sample pump 21-1 to the injection valve 22, supplies the cleaning liquid supplied by the pumping operation of the cleaning liquid pump 21-3 to the injection valve 22, or repeatedly moves the sample and the solvent between two pumps by the operation of the sample pump 21-1 and the fluid dissolving pump 21-2.

Meanwhile, the injection valve 22 includes an eluent injecting port 22-1, a sample injecting port 22-2, and a sample drawing port 22-3 and mixes the eluent delivered through the eluent injecting port 22-1 with the sample delivered through the sample injecting port 22-2 according to the control of the controller 10 and injects it to the column unit 5 through the sample drawing port 22-3.

The sample dissolving unit and the injecting unit having the above-mentioned configuration dissolves the sample in the sample reservoir 20, mixes the dissolved sample with the eluent and provides it to the column unit 5, or provides the cleaning liquid in the cleaning liquid reservoir (not shown) to the injection value 22, by the control of the controller 10 for the sample pump 21-1, the fluid dissolving pump 21-2, the cleaning pump 21-3, the valve 21-4, the ultrasonic oscillator 21-5, and the injection valve 22.

In the above-mentioned configuration, the sample reservoir 20 for storing the insoluble polymer, the ultrasonic oscillator 21-5 to uniformly dissolve the insoluble polymer by applying ultrasonic wave thereto in the high temperature state, and the fluid dissolving pump 21-2 that moves the sample and the solvent to dissolve the insoluble polymer sample in the high temperature state configures the sample dissolving unit 3 and the remaining component configures the injecting unit 4.

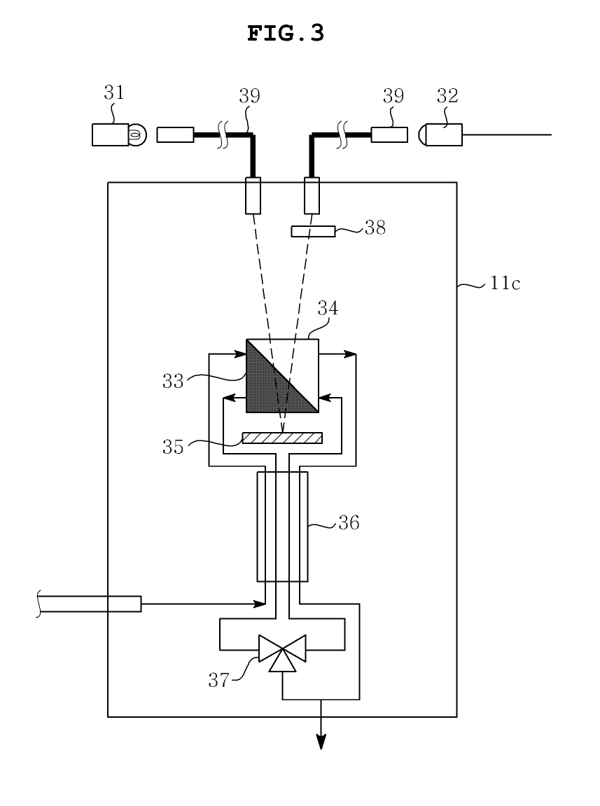

FIG. 3 is a configuration diagram of the detector of FIG. 1.

Referring to FIG. 3, the detector of FIG. 1 includes a light source 31, a light receiving device 32, a sample cell 33, a reference cell 34, a mirror 35, a heat exchanger 36, a three-way solenoid valve 37, a transparent plate 38, and an optical fiber assembly 39.

The light source 31 uniformly generates and emits light with a predetermined wavelength and may be a laser diode, a vertical external cavity surface-emitting laser (VECSEL) type laser, or an apparatus performing a function similar thereto.

Next, when the light receiving device 32 receives light emitted from the light source 31 through the sample cell 33 and the reference cell 34, it may be a photo diode to measure the light intensity.

The sample cell 33 contacts the reference cell 34 in a prism shape, is positioned on an optical path of light emitted from the light source 31 to partially absorb light input from the light source 31, and passes through the sample input from the column unit 5.

The reference cell 34 contacts the sample cell 33 in a prism shape, is positioned on an optical path of light emitted from the light source 31 and reflected from the mirror 35 to partially absorb light, and passes through the eluent as the reference materials.

The mirror 35 is to reflect light emitted from the light source 31 and transmitting the sample cell 33 toward the light receiving device 32 through the reference cell 34. As described above, as the mirror 35, a metallic curved mirror, dielectric multi-layer mirror, a total internal reflection mirror can be used, which reflects light approximating to about 100%.

The optical fiber assembly 39 separates the light receiving device and the light source in the high temperature region in order to prevent the light receiving device 32 and the light source 31 from generating noise and degrading performance at high temperature.

Next, the heat exchanger 36 has a structure such that the passage connecting the column unit 5 to the sample cell 33, the passage connecting the sample cell 33 to the reference cell 34, and the passage connecting the reference cell 34 to the discharging pipe contacts each other and maintains the same temperature by thermally contacting the sample input from the column unit 5 to the sample cell 33 to the eluent input to the reference cell 34.

The three-way solenoid valve 37 provides the sample passing through the sample cell 33 to the splitter 7 and provides a circulating path for the eluent input to the reference cell 34.

Meanwhile, the transparent plate 38 performs filtering to pass through only zero-order light from light emitted from the light source 31 and input through the sample cell 33 and the reference cell 34, such that the light receiving device 32 can measure accurate light intensity.

When the column unit 5 is normally operated to discharge the separated materials, the detector configured as described above injects the separated and injected sample material to the sample cell 33 and injects only the eluent into the reference cell 34 to detect the change in intensity of light emitted from the light source 31 when the materials passes through the sample cell 33 and the reference cell 34 by the light receiving device 32, thereby making it possible to separate the sample material.

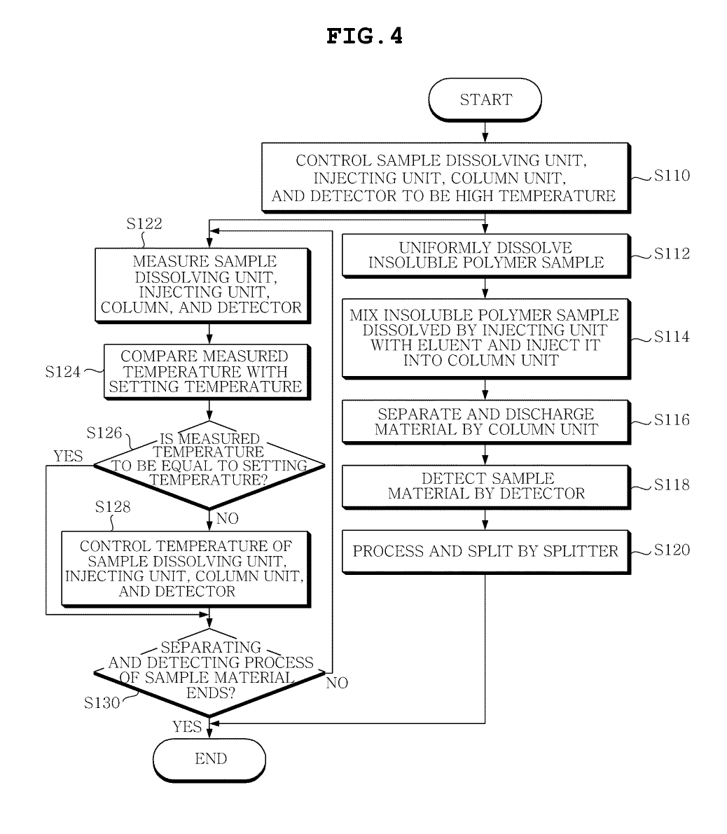

FIG. 4 is a flow chart of a high temperature chromatography method according to the first preferred embodiment of the present invention.

First, the controller compares the temperature of the sample dissolving unit, the injecting unit, the column unit, and the detector measured by the temperature measuring unit with the setting temperature.

The controller controls the heating device using the temperature controller when there is a difference between the setting temperature and the measured temperature in respects to comparing the result to increase and decrease the temperature of the sample dissolving unit, the injecting unit, the column unit, and the detector, in order to be the same as the setting temperature (S110).

Thereafter, the sample dissolving unit uses the sample pump, the fluid dissolving pump, and the ultrasonic oscillator to uniformly dissolve the insoluble polymer sample stored in the sample reservoir at high temperature (T>120° C.) (S112).

The injection unit uses the sample pump to deliver the dissolved insoluble polymer sample to the injection valve and mixes the eluent supplied from the eluent pump with the dissolved sample in the injection valve and injects it into the column unit (S114).

The temperature of the sample dissolving unit and the injecting unit is maintained to be same as the setting temperature by steps S122 to S130 as the process progressed, such that the precipitation and coagulation of the sample are prevented even after the sample is mixed with the eluent.

As described above, while the sample uniformly mixed with the eluent supplied from the eluent pump passes through the column unit configured of one of the temperature controllable reversed phase chromatography column, normal phase chromatography column, size-exclusion chromatography column, ion exchange chromatography column, and a combination of at least one thereof in the high temperature region (T>120° C.), it is separated according to molecular weight and chemical structure without precipitating, coagulating, and clogging (S116).

As described above, while the sample uniformly mixed with the eluent passes through the column unit, the precipitation and coagulation thereof are prevented since the temperature of the column unit is maintained to be the same as the setting temperature by steps S122 to S130.

Meanwhile, the temperature controller controls the heating device so that the temperature of the column unit is changed in an appropriate manner in the high temperature region (120° C. or more) according to the time function.

Further, the temperature controller controls the heating device to apply the temperature gradient method in the high temperature region so that the temperature of the column unit can be variously changed such as slowly increasing stepwise or slowly increasing and then, slowly decreasing in an appropriate manner in the high temperature region (120° C. or more) according to the time function.

The sample and the eluent passing through the column unit by the above-mentioned process are subjected to the detector configured of any one of the evaporation light scattering (ELSD) detector, the UV-Vis detector, and the refractive index detector that is maintained at high temperature and are detected without precipitating and clogging (S118). When the detector performs the temperature gradient experiment in the normally operable temperature range, it may perform a control so that the temperature of the detector is the same as that of the column unit.

Herein, the detecting process of the detector will now be described.

First, when the column unit separates materials to discharge the sample made of eluent and polymer, the reference cell included in the detector stores the discharged eluent as the reference material.

The detector controls the temperature of the discharged sample by the heat exchanger so that the temperature of the discharged sample is the same as the temperature of the reference material in the reference cell and then, passes the sample through the sample cell configuring the detector.

Thereafter, the detector generates and emits light through the sample cell and the reference cell from the light source and the light receiving device included in the detector measures the light intensity input through the sample cell and the reference cell to detect the desired material.

Through the above process, the sample detected in the detector is discharged to the splitter through the discharging pipe maintained at high temperature and the splitter automatically splits the separated polymer sample discharged from the discharging pipe over time (S120).

When the above process is progressed, the temperature measuring unit measures the representative temperature for each component by using one temperature sensor for each component or measures the temperature for each position of the components by using the plurality of temperature sensors (S122).

The temperature controller compares the temperature measured by the temperature measuring unit with the setting temperature (S124).

As a comparison result, when the temperature measured by the temperature measuring unit is the same as the setting temperature, it is performed from step S130 and when the temperature measured by the temperature measuring unit is different from the setting temperature, the temperature of the sample dissolving unit, the injecting unit, the column unit, and the detector is controlled (S128).

In this case, the temperature controller separately controls the heating device to set the temperature appropriate for each of the sample dissolving unit, the injecting unit, the column unit, and the detector when the heating device is separately installed on each of the sample dissolving unit, the injecting unit, the column unit, and the detector and controls the temperature of all the components when one heating device is installed from the sample dissolving unit to the detector.

Thereafter, the temperature controller determines whether the process of separating and detecting the sample material ends (S310) and if not, the process is repeatedly performed from step S122 and if so, the temperature control is not progresses any more.

According to the present invention, it can precisely perform the separation/analysis/purification in the process from preparation/injection of insoluble polymer samples that are dissolved at high temperature (120° C. or more) to separation, detection, and collection without precipitating the polymer or the coagulation of the mobile phase.

Further, the present invention can apply the thermal gradient method at a high temperature region (120° C. or more) that could not be performed by the TGIC according to the prior art, thereby making it possible to maximize the separation/analysis/purification effect

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A high temperature chromatography apparatus, comprising:
an eluent pump that supplies eluent used as a mobile phase stored in an eluent reservoir;
a sample dissolving unit that stores an insoluble polymer sample and uniformly dissolves the stored insoluble polymer sample at high temperature;
an injecting unit that mixes and injects the sample dissolved in the sample dissolving unit and the eluent supplied from the eluent pump;
a column unit that separates materials from a mixing solution of the sample injected from the injecting unit and the eluent;
a detector that detects desired materials from the materials separated and supplied from the column unit;
a temperature measuring unit that measures the temperature of the sample dissolving unit, the injecting unit, and the column unit;
a heating device that increases or decreases the temperature of the sample dissolving unit, the injecting unit, and the column unit;
a temperature controller that controls the heating device by comparing the temperature measured in the temperature measuring unit with a setting temperature to maintain the measured temperature and the setting temperature to be the same as each other; and
a controller that controls the sample dissolving unit, the eluent pump, the injecting unit, the detector, the temperature measuring unit, and the temperature controller.

2. The high temperature chromatography apparatus as set forth in claim 1, further comprising a splitter that is connected to a discharging pipe of the detector and processes and splits materials detected and discharged in the detector.

3. The high temperature chromatography apparatus as set forth in claim 1, wherein the eluent stored in the eluent reservoir is at least one of halogenated hydrocarbon[trichlorobenzene (TCB)], DMF, DMSO, m-Cresol, Pyridine, Tetrachloroethane, THF, NMP, Formic Acid, Sulfuric Acid, Phenyl-based organic solvent, and a combination thereof.

4. The high temperature chromatography apparatus as set forth in claim 1, wherein the insoluble polymer sample dissolved in the sample dissolving unit is at least one of a hydrocarbon-based sample, a conductive polymer sample, and an LCP polymer sample.

5. The high temperature chromatography apparatus as set forth in claim 1, wherein the column unit is one of a reversed phase chromatography column, a normal phase chromatography column, a size-exclusion chromatography column, an ion exchange chromatography column, and a combination of at least one thereof.

6. The high temperature chromatography apparatus as set forth in claim 1, wherein the detector is one of an evaporation light scattering (ELSD) detector, an UV-Vis detector, and a refractive index detector.

7. The high temperature chromatography apparatus as set forth in claim 1, wherein the temperature measuring unit includes a plurality of temperature sensors to separately measure temperature for each of the sample dissolving unit, injecting unit, column unit, and detector.

8. The high temperature chromatography apparatus as set forth in claim 1, wherein the heating device includes a plurality of heaters to separately increase or decrease the temperature of each of the sample dissolving unit, the injecting unit, the column unit, and the detector.

9. The high temperature chromatography apparatus as set forth in claim 1, wherein the sample dissolving unit includes:
a sample reservoir that stores an insoluble polymer sample;
an ultrasonic oscillator that applies an ultrasonic wave to the insoluble polymer in a high temperature state and uniformly dissolves the insoluble polymer; and
a fluid dissolving pump that moves the sample and the solvent to dissolve the insoluble polymer sample in a high temperature state.

10. The high temperature chromatography as set forth in claim 1, wherein the injecting unit includes:
a sample pump that supplies a sample in a dissolved state at high temperature; and
an injection value that includes an eluent injecting port, a sample injecting port, and a sample drawing port and mixes the eluent delivered through the eluent injecting port through the eluent pump with a sample delivered through the sample injecting port from the sample pump and injects the mixture to the column unit through the sample drawing port.

11. The high temperature chromatography as set forth in claim 1, wherein the detector includes:
a light source that uniformly generates and emits light having a predetermined wavelength;
a sample cell that passes through the sample input from the column unit and is positioned on an optical path of light emitted from the light source to partially absorb light input from the light source;
a reference cell that contacts the sample cell, passes through the eluent as the reference material, and is positioned on the optical path of light emitted from the light source to partially absorb light;
a mirror that reflects light input through the sample cell to pass through the reference cell;
a heat exchanger that allows a passage to transmit materials input and output to and from the sample cell and a passage to transmit the eluent input and output to and from the reference cell to be adjacent to each other to make the temperature of the internal material of the sample cell and the reference cell to be the same as each other during the temperature gradient experiment;
a light receiving device that measures the change in optical path due to the difference between refractive indexes of cell internal materials by passing light emitted from the light source through the sample cell and the reference cell; and
an optical fiber assembly used to separate the light source and the light receiving device in a high temperature region.

12. A high temperature chromatography method, comprising:
(A) measuring temperature of a sample dissolving unit, an injecting unit, a column unit, and a detector by a temperature measuring unit and allowing the temperature controller to compare the measured temperature with the setting temperature to control the temperature of the sample dissolving unit, the injecting unit, the column unit, and the detector to the setting temperature;
(B) uniformly dissolving an insoluble polymer sample by the sample dissolving unit;
(C) mixing the dissolved insoluble polymer sample with an eluent and injecting it into the column unit by the injecting unit;
(D) separating and discharging materials by the column unit and detecting sample materials by the detector; and
(E) measuring the temperature of the sample dissolving unit, the injecting unit, the column unit, and the detector by the temperature measuring unit as steps (B) to (D) progress and allowing the temperature controller to compare the measured temperature with the setting temperature so that the temperature of the sample dissolving unit, the injecting unit, the column unit, and the detector is maintained at setting temperature.

13. The high temperature chromatography method as set forth in claim 12, further comprising after step (D), (F) processing and splitting materials discharged by a splitter connected to the discharging pipe of the detector.

14. The high temperature chromatography method as set forth in claim 12, wherein the eluent stored in the eluent reservoir is at least one of halogenated hydrocarbon[trichlorobenzene (TCB)], DMF, DMSO, m-Cresol, Pyridine, Tetrachloroethane, THF, NMP, Formic Acid, Sulfuric Acid, Phenyl-based organic solvent, and a combination thereof.

15. The high temperature chromatography method as set forth in claim 12, wherein the insoluble polymer sample is at least one of a hydrocarbon-based sample, a conductive polymer sample, and an LCP polymer sample.

16. The high temperature chromatography method as set forth in claim 12, wherein step (A) includes:
(A-1) measuring the temperature of the sample dissolving unit, the injecting unit, the column unit, and the detector by the temperature measuring unit;
A-2) allowing the temperature controller to compare the measured temperature measured with the setting temperature; and
(A-3) when the temperature measured is different from the setting temperature, allowing the temperature controller to control the heating device to maintain the temperature of the sample dissolving unit, the injecting unit, the column unit, and the detector at the setting temperature.

17. The high temperature chromatography method as set forth in claim 12, wherein step (C) includes:
(C-1) delivering the eluent in the eluent reservoir to the injecting unit by using the eluent pump;
(C-2) delivering the polymer sample in the sample dissolving unit to the injecting unit in the state maintained at high temperature; and
(C-3) mixing the eluent delivered from the eluent pump with the sample delivered from the sample dissolving unit and injecting it to the column unit.

18. The high temperature chromatography method as set forth in claim 12, wherein step (D) includes:
(D-1) separating materials by the column unit and discharging the sample made of eluent and polymer;
(D-2) allowing the reference cell included in the detector to store the discharged eluent as a reference material;
(D-3) controlling the temperature of the discharged sample by using the heat exchanger so that the temperature of the discharged sample is equal to the temperature of the reference material in the reference cell and then, passing the sample through the sample cell configuring the detector;
(D-4) generating and emitting light passing through the sample cell and the reference cell from the light source included in the detector; and
(D-5) detecting desired materials by allowing the light receiving device included in the detector to measure light intensity input through the sample cell and the reference cell.

19. The high temperature chromatography method as set forth in claim 12, wherein step (E) includes:
(E-1) measuring the temperature of the sample dissolving unit, the injecting unit, the column unit, and the detector by the temperature measuring unit while the steps (B) to (D) are performed;
(E-2) allowing the temperature controller to compare the measured temperature with the setting temperature;
(E-3) when the measured temperature is different from the setting temperature, allowing the temperature controller to control the heating device to control temperature of the sample dissolving unit, the injecting unit, the column unit, and the detector; and
(E-4) determining whether the material separating process ends by the temperature controller and if not, repeating the steps (E-1) to (E-4).
